(19) United States
(12) Patent Application Publication
(10) Pub. No.: US 2006/0068194 A1
(43) Pub. Date: Mar. 30, 2006

(54) Flame retardant coating

(76) Inventor: Michael David Feldstein, Princeton, NJ (US)

Correspondence Address: Michael D. Feldstein;c/o Surface Technology, Inc., P.O. Box 8585, Trenton, NJ, 08650, US

(21) Appl. No.: 10/949,559

(22) Filed: Sep. 27, 2004

(51) Int. Cl. B32B 5/16; B32B 15/00

(52) U.S. Cl. 428/323; 428/615

(57) ABSTRACT

Disclosed is a description of articles with flame retardant and/or intumescent coatings. The flame retardant coatings include composite coatings with particulate matter within a metallic matrix where said particulate matter has flame retardant and/or intumescent properties. Articles with composites coatings incorporating more than one particulate matter and/or more than one coating layer are also disclosed.

### BACKGROUND OF THE INVENTION

The plating of articles with a composite coating bearing finely dispersed particulate matter is well documented. This technology has been widely practiced in the field of electroplating as well as electroless plating. The acceptance of such composite coating stems from the recognition that the inclusion of fine particulate matter within metallic matrices can significantly alter the properties of the coating such as wear resistance, lubricity, friction, thermal transfer, and appearance.

Electroless composite technology is a more recent development as compared to electrolytic composite technology. The fundamentals of composite electroless plating is documented in a text entitled “Electroless Plating Fundamentals and Applications,” edited by G. Mallory and J. B. Hajdu, Chapter 11, published by American Electroplaters and Surface Finishers Society (1990).

The evolution of composite electroless plating dates back to Oderkerken U.S. Pat. No. 3,614,183 in which a structure of composite electroless plating with finely divided aluminum oxide was interposed between electrodeposited layers to improve the corrosion resistance. Thereafter, Metzger et al, U.S. Pat. Nos. 3,617,363 and 3,753,667 extended the Oderkerken work to a great variety of particles and miscellaneous electroless plating baths. Thereafter, Christini et al in Reissue Pat. No. 33,767 further extended the composite electroless plating to the codeposition of diamond particles. In addition, Christini et al demonstrated certain advantages associated with the deposition of the barrier layer (strike) prior to the composite layer.

Feldstein in U.S. Pat. Nos. 4,358,922 and 4,358,923 demonstrated the advantages of utilizing a metallic layer above the composite layer. The overlayer is essentially free of any particulate matter. Spencer in U.S. Pat. No. 4,547,407 demonstrated the utilizing of a mixture of dual sized particles in achieving improved smoothness of coating.

Feldstein et al in U.S. Pat. Nos. 4,997,686, 5,145,517, 5,300,330, 5,863,616, and 6,306,466 B1 demonstrated utilization of particulate matter stabilizers in the deposition of uniform stable composite electroless plating. Parker in U.S. Pat. No. 3,723,078 demonstrated the codeposition of refractory metals and chromium along with composite electroless plating.

Helle et al in U.S. Pat. Nos. 4,098,654 and 4,302,374 explored special surfactant compositions in the preparation of stabilized PTFE dispersions and their subsequent utilization in electrolytic plating.

Kurosaki et al in U.S. Pat. No. 3,787,294 proposed the use of cationic stabilizers for graphite fluoride be used in electroplating with specific attention focused upon surfactants having a C—F bond in their structure.

Brown et al in U.S. Pat. No. 3,677,907, demonstrated the utilization of surfactants also having a C—F bond in their skeleton used in combination with PTFE electrolytic codeposition.

Henry et al in U.S. Pat. No. 4,830,889, demonstrated the utilization of a cationic fluorocarbon surfactant along with a non-ionic fluorocarbon surfactant for the codeposition of graphite fluoride in electroless plating baths.

Feldstein in U.S. Pat. Nos. 5,514,479, 5,516,591, and 5,834,065 demonstrated the novel inclusion of particles with light emitting properties into composite plated layers to create layers that can emit light for identification and authentication purposes.

Feldstein et al in U.S. Pat. No. 5,580,375 also demonstrated the use of “frozen states” to overcome the limited shelf-life associated with certain dispersions before their use in plating applications.

Kanai in U.S. Pat. No. 4,677,817 demonstrated travelers with composite carbide coatings for use in ring spinning.

Feldstein in U.S. Pat. No. 5,721,055 demonstrated benefits of composite coatings with lubricating particles on spinning textile machinery parts.

Feldstein in U.S. Pat. No. 6,309,583 demonstrated the ability to enhance the thermal transfer properties of articles coated with various composite coatings.

Feldstein et al in U.S. Pat. No. 6,506,509 demonstrated the ability to and utility of producing composite layers with varying densities of codeposited particles in the plated layer along the surface of the substrate.

The above patents reflect the state of the art and they are included herein by reference.

The above patents as well as the commercial uses of composite plating are limited coatings with particulate matter that is generally categorized as either hard, wear resistant, lubricating, thermal transferring, insulating, frictional, or light emitting. In none of the above patents or commercial practice can be found composite plated coatings incorporating particulate matter that is flame retardant, or one that will form an intumescent coating when heated.

This invention relates to articles with a flame retardant coating where said coating is a composite plated coating with flame retardant and/or intumescent particulate matter within a metallic matrix.

It is common practice to heat-treat many articles with coatings formed thereon. The purposes of such heat treatments typically may include hardening of the coating or improving the adhesion of the coating to the article. Nowhere in the prior art is any article with a composite plated coating where the particulate material within the coating intumesces or is modified by heating of the coating.

Flame retarding is an important area of concern. As is well presented in the attached United Nations Environment Programme, International Programme on Chemical Safety, Environmental Health Criteria 192, Flame Retardants: A General Introduction; the toll to human life and property is substantial. As this document points out, “In today's society, there is an unprecedented development in the size and number of buildings, skyscrapers, warehouses and methods of transport. Carpeting, furnishings, equipment, oil and gas for heating all increase the fire load in a building.” “Modern fire-fighting techniques, equipment and building design have reduced the destruction due to fires. However, a high fuel load in either a residential or commercial building can offset even the best of building construction.” “Each year, over 3 million fires leading to 29,000 injuries and 4,500 deaths are reported in the USA. The direct property losses exceed $8 billion and the total annual cost has been estimated at over $100 billion.”

Since ancient times a large number of methods have been developed to retard fires including material selection, chemical treatments, and protective coatings. Despite these efforts, certain requirements of fire protection have not been met due to the limitation of the methods developed to date.

The collapse of the World Trade Center buildings on Sep. 11, 2001 provided a devastating example. A May 2002 report on the tragedy by the Federal Emergency Management Agency and the American Society of Civil Engineers concluded that, “The fact that the structures were able to sustain this level of damage and remain standing for an extended period of time is remarkable and is the reason that most building occupants were able to evacuate safely.” However, as the report also notes, while, “the twin towers could have withstood the impact of the two hijacked Boeing 767 airliners that plowed into the trade center . . . The towers succumbed to the ensuing fire . . . that softened the buildings' steel framework.” One of the report's investigators said, “The impact of the jets is believed to have blown off the fluffy fireproofing material on the trade center's steel columns, making them susceptible to the intense heat from the ensuing fire.” A conclusion of the federal report was that, “Fireproofing that sticks to steel beams and emergency stairwells ‘hardened’ to withstand catastrophic impact of a plane should be included in high-risk buildings”

The “fluffy” fireproofing as used in the World Trade Centers is a common defense against fire. Another common method is to incorporate particles of flame retarding materials into painted layers used in building construction. An inherent deficiency of these two methods lie in their method of application to the structures they are intended to protect. Such materials to date are sprayed or painted onto structures. The bond between the fire retardants and the base material is therefore not optimal. The current invention relates to the composite plating onto materials for fireproofing purposes. Various plating methods are available where a metallurgical bond between the coating and the metal substrate is achieved. Further, it is possible to incorporate fine insoluble particles of fire retarding materials into the plated layer, thereby creating an integral composite. The composite layer can feature a metallurgical bond to the base metal and fireproofing properties. The improved adhesion of such coatings compared to spray applied materials is substantial, and leads to greater integrity of the structure to withstand both impact and fire. Articles coated with electroless varieties of composite plating also achieve the benefit of a uniform coating thickness of the plated layer on all surfaces of the article regardless of geometry of the article.

It is further within the scope of this invention to apply a composite plated layer as portrayed above plus the additional step of applying a secondary overcoat layer comprised of the same or other flame retardant material as utilized within the initial composite layer. Because of the protrusion of the flame retardant particulate material on the surface of the composite plated layer, the adhesion or bonding of the overcoat layer to the like material in the composite layer will be promoted. This could be used for polymerizing additional materials to the composite plated coating.

Articles that will benefit from this invention include, but are not limited to buildings, structural materials and accessories, vehicles and vehicular components, security devices, equipment enclosures, and other articles.

### BRIEF SUMMARY OF THE INVENTION

The present invention is for articles with a flame retardant and/or intumescent coating. The coatings included in the present invention are composite plated coatings with particulate matter with flame retardant and/or intumescent properties. A key benefit of the present invention is the strength, conformity, and adhesion of said coatings to articles. Articles with composites coatings incorporating more than one particulate matter and/or more than one coating layer are also included in the present invention.

### EXAMPLES

### Example 1

A one-liter solution of the electroless nickel-phosphorous plating bath commercially available as NiPlate® 830 from Surface Technology, Inc. of Trenton, N.J. was prepared according to the manufacturer's specifications. To this bath was added 5 grams of antimony trioxide. The particles were dispersed in the plating bath for five minutes. The plating bath was then heated to 85 degrees Celsius. A steel panel weighing approximately three grams with a surface area of about 20 square centimeters was cleaned and immersed in the plating bath. After 32 minutes of plating time, the coated panel was removed from the plating bath, rinsed and dried. A cross section of the coated panel was made, and microscopic examination revealed that the coating contained antimony trioxide particles within the metal matrix.

### Example 2

A 250 milliliter solution of the electrolytic nickel plating bath commercially available as NiLytic® 100 from Surface Technology, Inc. of Trenton, N.J. was prepared according to the manufacturer's specifications in an electrochemical cell. To this bath was added three grams of antimony trioxide. The particles were dispersed in the plating bath for ten minutes. The plating bath was then heated to 50 degrees Celsius. A steel panel weighing approximately three grams with a surface area of about 20 square centimeters was cleaned and immersed in the plating bath. After 40 minutes of plating at 0.3 amps current between a pure nickel metal anode and the steel panel, the coated panel was removed from the plating bath, rinsed and dried. This plating generated an increase of 0.20 grams on the panel. Microscopic examination revealed that the coating contained antimony trioxide particles within the metal matrix. The coated panel was then heated directly above a Bunsen burner flame. An intumescent reaction was observed on the surface of the coating as the panel was heated.

### Example 3

A 250 milliliter solution of the electrolytic nickel plating bath commercially available as NiLytic® 100 from Surface Technology, Inc. of Trenton, N.J. was prepared according to the manufacturer's specifications in an electrochemical cell. To this bath was added three grams of ammonium polyphosphate. The particles were dispersed in the plating bath for ten minutes. The plating bath was then heated to 50 degrees Celsius. A steel panel weighing approximately three grams with a surface area of about 20 square centimeters was cleaned and immersed in the plating bath. After 58 minutes of plating at 0.3 amps current between a pure nickel metal anode and the steel panel, the coated panel was removed from the plating bath, rinsed and dried. This plating generated an increase of 0.23 grams on the panel. Microscopic examination revealed that the coating contained particles within the metal matrix. A portion of the coating was removed from the panel by scraping. This removed coating was analyzed in an infrared spectrum that confirmed that the particles within the coating are ammonium polyphosphate. The coated panel was then heated directly above a Bunsen burner flame. An intumescent reaction was observed on the surface of the coating as the panel was heated.

### DESCRIPTION OF THE PREFERRED EMBODIMENTS

The most common methods of plating are electrolytic, electroless (also known as auto-catalytic or chemical plating), and brush. Such conventional plating is commonly used for corrosion protection, aesthetics, wear resistance, and other properties. Composite plating with particulate matter within the plated layer is widely used for hardness, wear resistance, frictional, lubricating, release, and other properties, but nowhere in the prior art has flame retardant particles been incorporated into plated layers for flame retarding properties. Articles with a composite plated coating incorporating flame retardant particles will achieve increased flame retardance via a coating that can conform to complex geometries with high adhesion. Such flame retarding composite plated coatings may further serve as an underlayer on which subsequent coatings may be applied for increased flame retardation or other functionality. Selection of the particulate material to incorporate into the composite plated coatings therefore may also be made to increase adhesion of the subsequent coating. One of the possible means by which this could be achieved is to incorporate into the composite plated coating particles of the same material as forming or included within the subsequent coating.

Articles on which such coatings or combinations of coatings may be beneficial include, but are not limited to, building and structural materials; internal building components; vehicle (aerospace, land and sea) structural elements, components, and housings; safety and security equipment and devices; computer and electronic equipment, military equipment; etc. Articles may be made of metal or nonmetal materials. Another improvement of the present invention is that the coatings disclosed herein can be applied to metal and nonmetal articles with precise conformity and excellent adhesion.

Selection of the appropriate plating matrix, particulate material, method of application, and coating specifications will depend on factors related to each application such as use, size, geometry, substrate material, and others. As there are a wide variety of such coating combinations, such coatings can be tailored to the requirements of each application.

A wide variety of plating matrices could be used including numerous metals and alloys applied by electroless, electrolytic, and other methods. Incorporated into this plated layer could be a large variety of particulate materials including flame-retardants and/or intumescent materials. Flame retardant materials generally function by releasing noncombustible gasses such as water and carbon dioxide that dilute flames. Other flame-retardants inhibit the burning process by quenching free radicals such as H⁺ nd OH⁻. Intumescent materials are those that upon exposure to heat intumesce into a char that decreases the thermal conductivity of the surface. These are generalizations of the physical and chemical phenomena involved, and not provided herein to restrict or limit the scope of this invention.

Possible materials for composite plating incorporation include, but are not limited to, Organophosphorous, Triphenyl Phosphate, Tricresyl Phosphate, Resorcinol bid(diphenylphosphate), Phosphorous and Nitrogen Containing Thermosets, Aluminum Trihydroxide, Magnesium Hydroxide, Ammonium Polyphosphate, Red Phosphorous, Zinc Borate, Melamine, Melamine Phosphates, Expandable Graphite, Antimony Oxides, and others including polymers and monomers. Some materials have flame retardant and/or smoke retardant and/or intumescent properties. Also included in this invention are articles with combination composite plated coatings incorporating more than one particulate material with flame retardant and/or intumescent properties. Such combination composite plated coatings will provide enhanced and/or multiple properties and/or synergistic benefits.

It is also within the scope of this invention to incorporate additional particulate material of other purposes such as hardness, wear resistance, friction, lubricity and others within the coating in addition to the flame retardant material to provide additional functional properties.

Listing Of References

Inventors: Dumas, Phillip; (Morrisville, PA)

Feldstein; Michael (Princeton, NJ)

Assignee: Surface Technology, Inc. (Trenton, NJ)

| | | | References Cited |
|---|---|---|---|
| | | | [Referenced By] |
| | | | U.S. Patent Documents |
| Re33767 | December, 1991 | Christini | 428/544. |
| 3614183 | October, 1971 | Berens | 384/486. |
| 3617363 | November, 1971 | Metzger | 384/486. |
| 3677907 | July, 1972 | Brown | 205/109. |
| 3723078 | March, 1973 | Parker | 428/559. |
| 3753667 | August, 1973 | Metzger | 428/639. |
| 3787294 | January, 1974 | Kurosaki | 205/109. |
| 4098654 | July, 1978 | Helle | 205/50. |
| 4193253 | March, 1980 | Herbert | 57/414. |
| 4302374 | November, 1981 | Helle | 524/168. |
| 4358922 | November, 1982 | Feldstein | 57/401. |
| 4358923 | November, 1982 | Feldstein | 57/401. |
| 4547407 | October, 1985 | Spencer | 427/367. |
| 4622170 | November, 1986 | Raasch | 57/416. |
| 4663929 | May, 1987 | Raasch | 57/416. |
| 4666786 | May, 1987 | Yano | 428/544. |
| 4677817 | July, 1987 | Kanai | 57/125. |
| 4830889 | May, 1989 | Henry | 427/438. |
| 4866927 | September, 1989 | Fetzer | 57/416. |
| 4885905 | December, 1989 | Maruta | 57/119. |
| 4928477 | May, 1990 | Kalitzki | 57/416. |
| 4997686 | March, 1991 | Feldstein | 427/443. |
| 5086615 | February, 1992 | Bodnar | 57/120. |
| 5514479 | May, 1996 | Feldstein | 461/455 |
| 5516591 | May, 1996 | Feldstein | 295/563 |
| 5145517 | September, 1992 | Feldstein | 106/605. |
| 5164236 | November, 1992 | Schmid | 428/344. |
| 5265406 | November, 1993 | Hofmann | 57/417. |
| 5300330 | April, 1994 | Feldstein | 427/443. |
| 5313773 | May, 1994 | Poquette | 57/119. |
| 5389229 | February, 1995 | Feldstein | 427/304. |
| 5580375 | December, 1996 | Feldstein | 106/1.05 |
| 5721055 | February, 1998 | Feldstein | 428/457 |
| 5834065 | November, 1998 | Feldstein | 446/129 |
| 5863616 | January, 1999 | Feldstein | 427/443.1 |
| 6306466 | October, 2001 | Feldstein | 427/437 |
| 6309583 | October, 2001 | Feldstein | 264/460 |
| 6506509 | January, 2003 | Feldstein | 428/702 |

What we claim is:

1. An article with a coating formed thereon, said coating consisting essentially of particulate matter within a metal matrix wherein said particulate matter has flame retardant and/or intumescent properties.

2. The article according to claim 1 wherein said article is heat-treated after said coating is applied.

3. The article according to claim 1 wherein said metal matrix is applied by an electroless plating method.

4. The article according to claim 1 wherein said metal matrix is applied by an electrolytic plating method.

5. The article according to claim 1 wherein said metal matrix is nickel metal.

6. The article according to claim 1 wherein said metal matrix is a nickel alloy.

7. The article according to claim 1 wherein said metal matrix is electroless nickel-phosphorous.

8. The article according to claim 1 wherein said metal matrix is electroless nickel-boron.

9. The article according to claim 1 wherein said metal matrix is electroless nickel-phosphorous-tungsten.

10. The article according to claim 1 wherein said metal matrix is electrolytic nickel.

11. The article according to claim 1 wherein said coating also contains particulate matter that is not primarily characterized as flame retardant and/or intumescent properties.

12. The article according to claim 1 wherein said coating also contains particulate matter that is wear resistant.

13. The article according to claim 1 wherein said coating also contains particulate matter that is lubricious.

14. The article according to claim 1 wherein said coating also contains particulate matter that is light emitting.

15. The article according to claim 1 wherein said coating also contains particulate matter that contains diamond.

16. The article according to claim 1 wherein said coating contains more than one particulate matter with flame retardant and/or intumescent properties.

17. The article according to claim 1 where one or more subsequent coatings is applied to said coating.

18. The article according to claim 1 wherein said particulate matter promotes the adhesion of subsequent materials or coatings to said coating.

19. The article according to claim 1 where said article is metal.

20. The article according to claim 1 where said article is steel or a steel alloy.

21. The article according to claim 1 where said article is a nonconductor.
